(19) United States
(12) Patent Application Publication
(10) Pub. No.: US 2009/0108146 A1
(43) Pub. Date: Apr. 30, 2009

(54) Low ergonomic grommet and method of making

(76) Inventors: Joseph A. Svette, JR., Newton Falls, OH (US); Theodore J. Borowicz, Flat Rock, MI (US)

Correspondence Address: DELPHI TECHNOLOGIES, INC., M/C 480-410-202, PO BOX 5052, TROY, MI, 48007, US

(21) Appl. No.: 11/981,038

(22) Filed: Oct. 31, 2007

(51) Int. Cl. F16L 5/02; B27N 3/08

(52) U.S. Cl. 248/56; 264/239; 277/606

(57) ABSTRACT

A grommet for use in a panel. The grommet including a panel mounting portion that seats in a hole defined in the panel. The panel mounting portion has a bearing surface. A textured layer is disposed on at least a part of the bearing surface to help reduce friction between the bearing surface and the panel as they contact each other when the grommet is installed in the panel.

### FIELD OF THE INVENTION

This invention relates generally to grommets used in panels to receive wire harnesses, and more particularly to such grommets designed to facilitate seating in the panels.

### BACKGROUND OF THE INVENTION

In an automobile, grommets are commonly inserted or seated in holes defined in panels to, among other things, shield wire harnesses passed through the holes, seal the holes, and reinforce the holes. Some grommets have bearing surfaces which rub against or otherwise contact edges of the holes during installation. Such contact can sometimes generate friction between the grommet and the panel which may increase the force needed for installation.

### SUMMARY OF THE INVENTION

In one aspect, a grommet has a panel mounting portion that is made for being seated in a hole defined in a panel. The panel mounting portion has a bearing surface with a textured layer that is disposed on at least a part of the bearing surface. The textured layer may help reduce friction between the bearing surface and the panel during installation.

In another aspect, a grommet has a door mounting portion, a body mounting portion, and a passage. The door mounting portion is made to be seated in a first hole defined in an automobile door panel. The door mounting portion has a first bearing surface with a first textured layer that is disposed on at least a part of the first bearing surface. The body mounting portion is made to be seated in a second hole defined in an automobile body panel. The body mounting portion has a second bearing surface with a second textured layer that is disposed on at least a part of the second bearing surface. The passage is made to receive a wire harness, and is defined in both the door mounting portion and the body mounting portion. The passage extends between the door mounting portion and the body mounting portion.

In another aspect, a method of forming a grommet that is for receiving a wire harness and that is installed in a panel includes injection molding and texturing. A body is injection molded to form a panel mounting portion made to be seated in a hole defined in a panel. The panel mounting portion has a bearing surface that may contact the panel when the grommet is installed in the panel. The texturing is performed on at least a part of the bearing surface.

### BRIEF DESCRIPTION OF THE DRAWINGS

FIG. 1 is a perspective view of an example embodiment of a grommet used to pass a wire harness (shown in phantom) through a hole defined in a panel (shown in phantom); and

FIG. 2 is a sectional view taken along line 2-2 of FIG. 1.

### DETAILED DESCRIPTION OF THE PREFERRED EMBODIMENTS

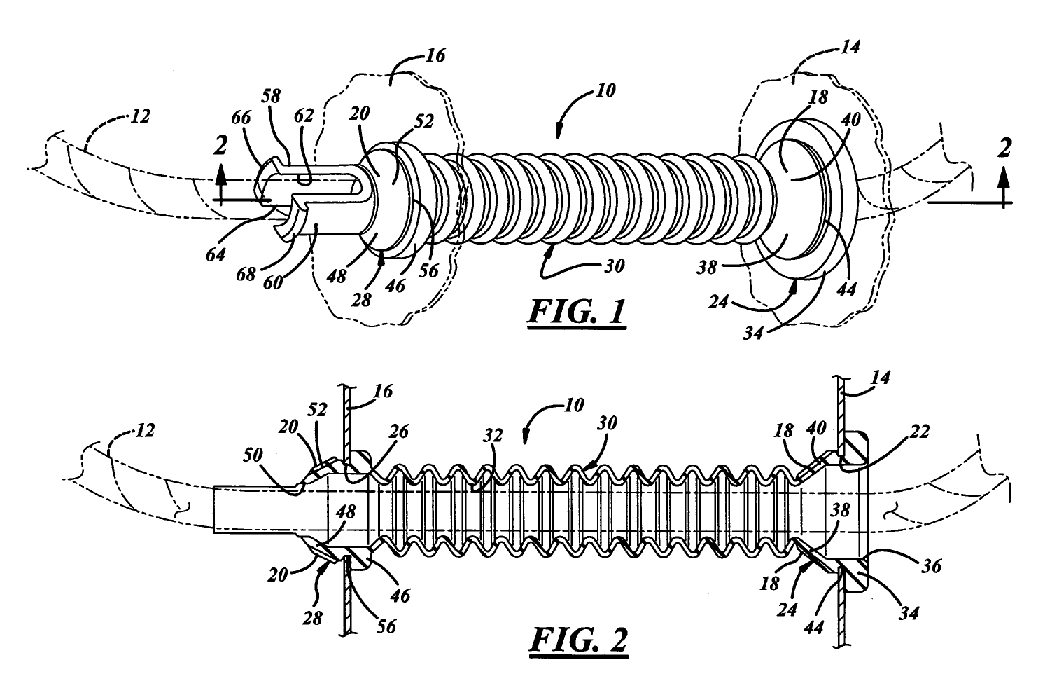

Referring now to the drawings, FIGS. 1 and 2 shown an example embodiment of a grommet 10 that may be used in an automobile to pass a wire harness 12 (phantom), or a bundle of wires, through and between a door panel 14 and a body panel 16 (both phantom). The grommet 10 is installed in each of the panels 14, 16 to seat a respective portion of the grommet 10 in a hole defined in each panel, as will be described. A first textured layer 18 and a second textured layer 20 are provided on the portions of the grommet 10 that may contact the respective panels, 14, 16 during installation. This way those portions can be seated in the panels 14, 16 with reduced friction and ergonomically easier than compared with similar portions without textured layers.

As shown, the grommet 10 has a generally cylindrical shape that intrinsically defines several directions with respect to that shape. For example, “axially” describes a direction that is generally along an axis, such as an imaginary center axis defined by the grommet 10. In the same way, “circumferentially” describes a direction that is generally along a circumference, such as an imaginary circumference defined by the grommet 10; and “radially” describes a direction that is generally along a radius, such as an imaginary radius defined by the grommet 10.

Referring to FIG. 2, the grommet 10 passes the wire harness 12 between the door panel 14 and the body panel 16 adjacent a vehicle door hinge (not shown) in an associated automobile. The door panel 14 defines a first hole 22 for seating a door mounting portion 24, and the body panel 16 defines a second hole 26 for seating a body mounting portion 28. An intermediate portion 30 extends between the door mounting portion 24 and the body mounting portion 28 to connect the two portions. A passage 32 is defined continuously from the door mounting portion 24, through the intermediate portion 30, and to the body mounting portion 28.

Referring to FIGS. 1 and 2, the door mounting portion 24 is used to mount one end of the grommet 10 in the door panel 14. That is, the door mounting portion 24 is constructed to seat, or be supported in the first hole 22. The door mounting portion 24 may have a first enlarged diameter section 34 that defines a first opening 36. The first enlarged diameter section 34 is the radially-most protruding section of the door mounting portion 24. The exact axial thickness of the first enlarged diameter section 34 will depend on, among others things, the desired force needed to unseat the door mounting portion 24 (i.e., the greater the axial thickness, the greater the needed force). The door mounting portion 24 also may have a first frusto-conical section 38 that is slanted radially inward or tapered toward the intermediate portion 30. The first frusto-conical section 38 has a first bearing surface 40 that constitutes the entire outermost surface of the first frusto-conical section. Parts of the first bearing surface 40 may bear against or contact the edges of the first hole 22 of the door panel 14 during installation.

The first textured layer 18 may be provided on at least a part of the first bearing surface 40 to help reduce friction that could be generated between the door panel 14 and the first bearing surface 40, when the grommet 10 is installed in the door panel. Depending on the exact technique used, the resulting textured layer may be a separate layer applied to the first bearing surface 40 or may be a layer formed out of the first bearing surface 40 itself. The first textured layer 18 reduces friction by, among other things, decreasing the contacting surface areas that are rubbed against each other during installation. The first textured layer 18 may cover just part of the first bearing surface 40 that is rubbed, may be patterned, or may cover the entire first bearing surface 40 as shown. The exact thickness throughout the textured layer 18 may be constant, or may vary. For example, the thickness may gradually increase toward the first enlarged diameter section 34. The gradual increase will help maintain the door mounting portion 24 seated in the first hole 22. The first textured layer 18 may be provided on the first bearing surface 40 by surface texturing techniques known to skilled artisans such as laser surface texturing, arc texturing, etching, film processing, or the like. One film processing technique involves applying a set of films one atop another and is provided by Tenibac Graphion, Inc. of Clinton Township, Mi. USA (www.tenibac.com).

The door mounting portion 24 may also have a first mounting groove 44 defined continuously and circumferentially in the door mounting portion between the first enlarged diameter section 34 and the first frusto-conical section 38. The first mounting groove 44 receives and captures the edges of the first hole 22 of the door panel 14 between its surfaces when the grommet 10 is seated therein.

Still referring to FIGS. 1 and 2, the body mounting portion 28 is used to mount the other end of the grommet 10 in the body panel 16. That is, the body mounting portion 28 is constructed to seat, or be supported in the second hole 26. The body mounting portion 28 may have a second enlarged diameter section 46 that constitutes the radially-most protruding section of the body mounting portion 28. The body mounting portion 28 may also have a second frusto-conical section 48 that is radially slanted away from, or tapered away from the intermediate portion 30. The second frusto-conical section 48 may define a second opening 50. A second bearing surface 52 constitutes the entire outermost surface of the second frusto-conical section 48, and parts of the second bearing surface may bear against or contact the edges of the second hole 26 when the body mounting portion 28 is being seated in the body panel 16. The second textured layer 20 is provided on at least a part of the second bearing surface 52 to help reduce friction that could be generated between the body panel 16 and the second bearing surface 52 when the grommet 10 is installed in the body panel. The second textured layer 20 may be applied by the same techniques, and constructed and arranged in the same way as described above for the first textured layer 18, so that a repeated description will not be given here.

The body mounting portion 28 may also have a second mounting groove 56 defined continuously and circumferentially in the body mounting portion between the second enlarged diameter section 46 and the second frusto-conical section 48. The second mounting groove 56 receives and captures the edges of the second hole 26 of the body panel 16 between its surfaces when the grommet 10 is seated in the second hole.

A first and a second arm 58 and 60 may extend axially from the body mounting portion 28 at the second frusto-conical section 48 to help support the wire harness 12. As shown, the first and second arm 58, 60 each have a slight curvature when viewed in a radial cross-section. Referring to FIG. 1, the first and second arm 58, 60 are oppositely disposed about the second frusto-conical section 48 and define a first and a second slot 62 and 64. A first and a second bead 66 and 68 may be formed as a radially projecting rim at the free ends of the respective first and second arms 58, 60. The first and second bead 66, 68 can be used when taping the wire harness 12 to the first and second arm 58, 60 after the wire harness is received through the passage 32.

The intermediate portion 30 may extend between the door mounting portion 24 and the body mounting portion 28 to expand and contract as the associated vehicle door hinge is opened and closed. As shown, the intermediate portion 30 is bellow-shaped, or corrugated to impart flexibility in it. The passage 32 is for receiving the wire harness 12 and for passing the wire harness through the grommet 10. The passage 32 may be defined by the entire body of the grommet 10, and may extend continuously from the first opening 36 to the second opening 50. Skilled artisans will know that regions of the passage 32—such as that bounded by the door mounting portion 24 and that bounded by the body mounting portion 28—may be sealed by potting after the grommet 10 is installed in the respective panels.

The grommet 10 may be made in a one-piece body by in an injection molding process as will be known by skilled artisans. The grommet 10 may be made out of an elastomer material, such as ethylene propylene diene monomer (EPDM) rubber, or the like.

In use, the grommet 10 is installed between the door panel 14 and the body panel 16 to pass the wire harness 12 between the panels. The door mounting portion 24 is seated in the first hole 22, and the body mounting portion 28 is seated in the second hole 26. When being installed, the door mounting portion 24 is inserted in the first hole 22 with the first frusto-conical section 38 leading the way. The edges of the first hole 22 may rub against the first textured layer 18 and more easily slide into the first mounting groove 44, The body mounting portion 28 is similarly inserted in the second hole 26 with the second frusto-conical section 48 leading the way. The edges of the second hole 26 may rub against the second textured layer 20 and more easily slide into the second mounting groove 56.

Although shown and described as a grommet that passes a wire harness between two panels and thus has two panel mounting portions, the grommet 10 may instead have only a single panel mounting portion that passes a wire harness through a single panel whether it be a door panel, a body panel, or other sheet metal panel. In that case, the grommet may not include an intermediate portion. The panel mounting portion may have one enlarged diameter section, one frusto-conical section with one bearing surface, and one mounting groove. A textured layer may be provided on the bearing surface to help reduce friction during installation. Two examples of such a grommet may be envisioned by skilled artisans if the example grommet 10 of FIGS. 1 and 2 is severed at either end of the intermediate portion 30 leaving only the door mounting portion 24 or the body mounting portion 28.

It will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. A grommet comprising:
a panel mounting portion constructed to be seated in a hole defined in a panel, the panel mounting portion having a bearing surface with a textured layer disposed on at least a part thereof to reduce friction between the bearing surface and the panel during installation.

2. The grommet of claim 1 wherein the panel mounting portion has an enlarged diameter section at one end, a frusto-conical section at another end being tapered away from the enlarged diameter section, and a mounting groove defined between the enlarged diameter section and the frusto-conical section for receiving the panel when the grommet is seated in the hole of the panel.

3. The grommet of claim 2 wherein the panel mounting portion defines a passage for receiving a wire harness, the passage having a first opening at the enlarged diameter section and a second opening at the frusto-conical section.

4. The grommet of claim 2 wherein the bearing surface constitutes the outermost surface of the frusto-conical section, and the textured layer is disposed over the entire bearing surface.

5. The grommet of claim 4 wherein the textured layer is applied to the bearing surface by a film process.

6. A grommet comprising:
a door mounting portion constructed to be seated in a first hole defined in an automobile door panel, the door mounting portion having a first bearing surface with a first textured layer disposed on at least a part thereof;
a body mounting portion constructed to be seated in a second hole defined in an automobile body panel, the body mounting portion having a second bearing surface with a second textured layer disposed on at least a part thereof; and
a passage defined in both the door mounting portion and the body mounting portion and extending therebetween, the passage being constructed to receive a wire harness.

7. The grommet of claim 6 further comprising an intermediate portion extending between the door mounting portion and the body mounting portion, the intermediate portion being corrugated to expand and contract when the grommet is stretched and compressed between the door panel and the body panel.

8. The grommet of claim 7 wherein the door mounting portion has a first enlarged diameter section at one end, a first frusto-conical section at another end being tapered toward the intermediate portion, and a first mounting groove defined between the first enlarged diameter section and the first frusto-conical section for receiving the door panel when the grommet is seated in the first hole of the door panel, and wherein the body mounting portion has a second enlarged diameter section at one end, a second frusto-conical section at another end being tapered away from the intermediate portion, and a second mounting groove defined between the second enlarged diameter section and the second frusto-conical section for receiving the body panel when the grommet is seated in the second hole of the body panel.

9. The grommet of claim 8 wherein the first bearing surface constitutes the outermost surface of the first frusto-conical section, and the first textured layer is disposed over the entire first bearing surface, and wherein the second bearing surface constitutes the outermost surface of the second frusto-conical section, and the second textured layer is disposed over the entire second bearing surface.

10. The grommet of claim 8 wherein the body mounting portion further has a first and a second arm both extending from the second frusto-conical section with a first and a second slot defined between the first and second arm, and wherein a first bead is formed at a free end of the first arm and a second bead is formed at a free end of the second arm, the first and second beads used when taping the first and second arms to the wire harness after installation.

11. The grommet of claim 9 wherein the first and second textured layers are applied to the respective first and second bearing surfaces by a film process.

12. A method of forming a grommet for receiving a wire harness and for installation in a panel, the method comprising:
injection molding a body to include a panel mounting portion constructed to be seated in a hole defined in the panel, the panel mounting portion having a bearing surface for contact with the panel during installation; and
texturing at least a part of the bearing surface.

13. The method of claim 12 wherein the injection molding step further comprises the panel mounting portion being a door mounting portion and a body mounting portion, the door mounting portion having a first bearing surface and the body mounting portion having a second bearing surface.

14. The method of claim 13 wherein the texturing step further comprises applying a first textured layer on the first bearing surface and applying a second textured layer on the second bearing surface.
